(19) United States
(12) Patent Application Publication
(10) Pub. No.: US 2010/0070108 A1
(43) Pub. Date: Mar. 18, 2010

(54) Transfer means for a freeze drying plant

(76) Inventors: Hubert Kluetsch, Cologne (DE); Johannes Selch, Pfungstadt (DE)

Correspondence Address: COLLARD & ROE, P.C., 1077 NORTHERN BOULEVARD, ROSLYN, NY, 11576, US

(21) Appl. No.: 12/586,015

(22) Filed: Sep. 16, 2009

(30) Foreign Application Priority Data
Sep. 18, 2008 (DE) 20 2008 012 379.8

(51) Int. Cl. B65G 49/00; G01C 21/00; G06F 19/00

(52) U.S. Cl. 701/2; 414/172; 701/207

(57) ABSTRACT

For realizing short loading periods with a flexible transfer means (10) for a freeze drying plant comprising at least one freeze drying station (12) and at least one loading station (14,16), wherein said the transfer means (10) comprises at least one supporting frame (18) having a loading area (22) and an electrically operated laminar flow means (28) for producing a laminar air flow (30) in the loading area (22), said the transfer means (10) comprises a lifting carriage (16) which is adapted to be mechanically connected with said the supporting frame (18) for lifting and moving said the supporting frame (18) and comprises a drive motor and a steering means.

### FIELD OF THE INVENTION

The present invention relates to a transfer means for a freeze drying plant and to a freeze drying plant.

### BACKGROUND OF THE INVENTION

Freeze drying plants are used for lyophilization, for example in the pharmaceutical industry, and typically comprise a plurality of freeze drying stations and at least one loading and one unloading station. In the loading station a package of small bottles containing the substance to by freeze-dried is created on a loading table. For transferring the bottle packages provided on the loading table into the respective freeze drying station, normally transfer carriages movable on rails are used, wherein first the bottle package provided on the loading table of the loading station is moved into the loading area of the transfer carriage. The transfer carriage then travels on the rails over a predetermined distance to the respective freeze drying station where the bottle package is pushed by a pushing element from the loading area of the transfer carriage into the freeze drying station. Each freeze drying station accommodates bottle packages which are stacked one above the other in several levels such that the transfer carriage must travel between the loading station and the respective freeze drying station several times for loading the freeze drying station.

For freeze drying purposes clean room conditions must prevail in the freeze drying plant in order to prevent contamination of the product to be freeze-dried. The same clean room conditions must also prevail in the loading area of the transfer carriage to prevent a contamination from occurring already during the transport.

For this purpose, the transfer carriage comprises a laminar flow means arranged above the loading area for producing a laminar air flow in the loading area. Said laminar flow means cleans the air and produces a laminar flow which flows through the loading area and is fed out of the transfer carriage for transporting any contamination particles out of the loading area and keep them away from said loading area.

Typically, class A clean room conditions must prevail in the loading area of the transfer carriage. Outside the transfer carriage and outside the freeze drying stations class B clean room conditions must prevail in the area where the transfer carriage moves. The class A clean room conditions must prevail in the loading area of the transfer carriage even when no product is transferred since otherwise complex evidence must be provided that the product to be freeze-dried is not contaminated by contaminants in the loading area.

The distance travelled by a transfer carriage moving on rails is predetermined. When a freeze drying plant is extended or enlarged the rail system must be adapted accordingly.

### SUMMARY OF THE INVENTION

It is an object of the present invention to provide a flexible transfer means for a freeze drying plant, having a simplified structure and allowing shorter loading periods. Further, the present invention provides a freeze drying plant.

According to the invention, the transfer means comprises a lifting carriage adapted to be mechanically connected with a supporting frame for lifting and moving the supporting frame of the transfer means, and is provided with a drive motor and a steering means. The lifting carriage can be moved by the drive motor and the steering means independently of the supporting frame of the transfer means. The path to be travelled by the lifting carriage can be flexibly determined by the drive motor and the steering means and is not predetermined by a rail system. The lifting carriage can be moved below the supporting frame to be mechanically connected therewith and can lift said supporting frame such that the latter can be flexibly moved by the lifting carriage.

For loading the transfer means, the lifting carriage can place the supporting frame in front of a loading station such that the product to be freeze-dried is loaded from the loading station into the loading area of the transfer means. When the loading process is terminated, the lifting carriage can move the supporting frame over a freely selected path to the respective freeze drying station where the product is transferred in a conventional manner from the loading area into the freeze drying station. Here, the laminar flow means allows for continuous operation and thus clean room conditions both in the loaded and the unloaded state of the supporting frame.

The lifting carriage can be disconnected from the supporting frame. Thus the lifting carriage can place the supporting frame in front of a loading station, for example, and transfer, during the loading process, another supporting frame from another loading station to a freeze drying station. Further, the lifting carriage can place a supporting frame in a separate area provided for maintenance, cleaning and/or sterilization purposes and transport another supporting frame while the maintenance, cleaning and/or sterilization work is carried out. It is particularly advantageous when the supporting frame, the lifting carriage or the entire transfer means is designed for sterilization with H₂O₂ gas (VHP). Due to the disconnectable lifting carriage the transfer means is more flexible and can travel the freely selectable path without being confined to a rail system. Thus shorter loading periods can be realized.

The lifting carriage may comprise an energy supply means and be adapted to be connected with the supporting frame such that the laminar flow means is supplied with the required energy by the energy supply means. The lifting carriage can be moved to a separate area for maintenance, cleaning and/or sterilization of the lifting carriage, the drive motor and/or the steering means without the supporting frame being carried along. For example, during maintenance of a lifting carriage the respective supporting frame can be transported by another lifting carriage such that the maintenance of the drive and/or the steering means of the transfer means does not impede loading of the freeze drying stations.

Preferably, coupling elements are provided at the freeze drying station and/or the loading station, which engage with a corresponding coupling means of the transfer means to allow precise positioning of the transfer means relative to the respective freeze drying station or loading station. Preferably, the coupling elements are truncated upwardly extending projections and the coupling means has a corresponding complementary configuration such that by lowering the lifting carriage the coupling elements engage with the coupling means and lowering allows the supporting frame to be automatically positioned in place. Due to the mechanical engaging of the coupling means with the coupling elements the supporting frame is fixed in place in the lowered state thus preventing shifting when a freeze drying station is loaded.

The coupling means and the coupling elements may comprise electrical contacts which, when coupled, establish an electrical connection serving for switching on certain operating functions of the transfer means and/or the freeze drying station and/or the loading station. For example, via the electrical contact the laminar flow means and/or the pushing element for pushing the product to be freeze-dried can be supplied with energy or a battery in the lifting carriage can be charged.

The lifting carriage may have a larger width than the supporting frame, wherein the width of the lifting carriage preferably amounts to a multiple of the width of the supporting frame such that the lifting carriage can accommodate and transport a plurality of supporting frames arranged side by side. This increases the flexibility of the transfer means.

Preferably, the transfer means comprises a navigation device for determining its position. The navigation device may be provided at the supporting frame and determine the relative position to a freeze drying station and/or a loading station. Alternatively or additionally, the lifting carriage may comprise a navigation device for determining the relative position to the supporting frame. For receiving control commands a data transmission interface, e.g. in the form of a WLAN interface, is provided at the transfer means for receiving control commands for the drive motor and the steering means. The control commands are transmitted as a function of the position determined before by the navigation device. The navigation device may in a conventional manner be provided as a laser navigation system comprising mirrors, for example. The positional data can be transmitted via the data transmission interface to a control computer. The control computer, like a control center, can receive and process the positional data of all transfer means of a dry freezing means and subsequently send individual control commands to each transfer means, said control commands allowing the respective lifting carriage to be moved without any collisions.

The loading station of the freeze drying means may comprise a conveying means, e.g. a conveyor belt, for conveying the product to be freeze-dried directly into the loading area of a correspondingly positioned transfer means. Thus the bottle package transferred by the transfer means to the freeze drying station can be directly created in the loading area of the supporting frame. The loading area then serves as loading and unloading table without any separate loading and unloading table being required at the loading station.

### BRIEF DESCRIPTION OF THE DRAWINGS

Hereunder an embodiment of the invention is described in detail with reference to the drawings in which:

FIG. 1 shows a schematic representation of a lateral view of a transfer means,

FIG. 2 shows a schematic representation of a top view of the transfer means of FIG. 1, and

FIG. 3 shows a schematic representation of a top view of a freeze drying plant.

### DETAILED DESCRIPTION OF PREFERRED EMBODIMENTS OF THE INVENTION

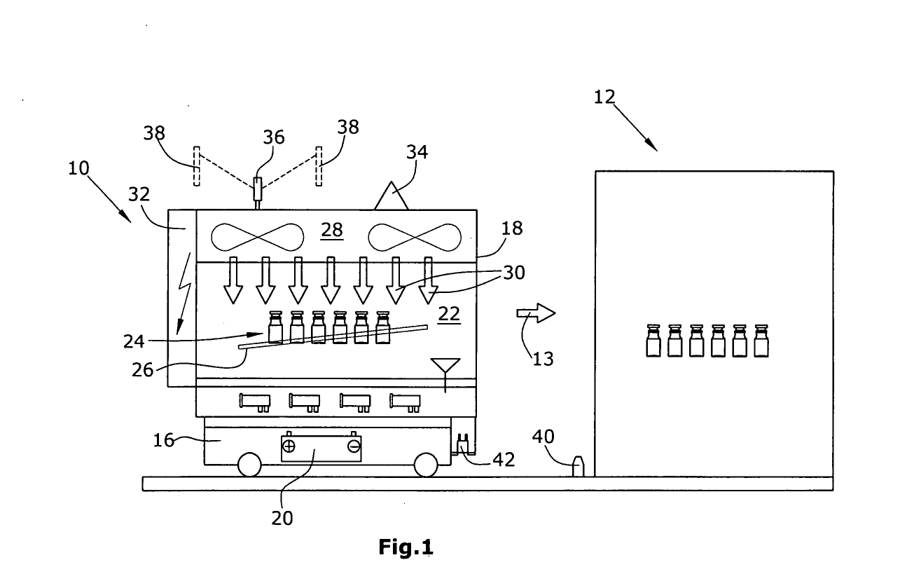

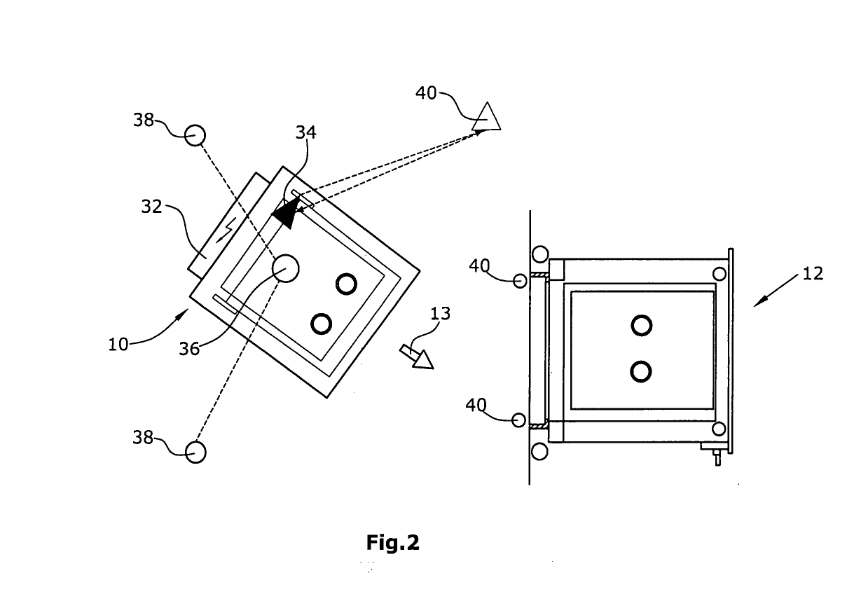

FIGS. 1 and 2 show a schematic simplified representation of a transfer means 10 in front of a freeze drying station 12, wherein the transfer means 10 approaches the freeze drying station 12 in the direction of an arrow 13 for loading purposes.

The transfer means 10 comprises a supporting frame 18 carried by a lifting carriage 16. Said lifting carriage 16 comprises mechanical receiving devices (not shown) for the supporting frame 18, wherein by lifting the lifting carriage 16 the supporting frame 18 is accommodated and retained in the receiving devices. In the lowered state of the lifting carriage 16 not shown in the Figures the receiving devices are free and the supporting frame 18 is located on the floor such that the lifting carriage 16 can be moved away from the supporting frame 18.

The lifting carriage 16 comprises an energy supply means 20 in the form of a battery having servomotors (not shown in the Figs.) for the drive motor, the steering means and the lifting means.

The supporting frame 18 of the transfer means 10 comprises a central loading area 22 in which a bottle package 24 composed of a certain number of small bottles containing a product to be freeze-dried is arranged. Said bottle package 24 is loaded with a pusher frame 26 from a loading station into the loading area of the transfer means. Above the loading area 22 a laminar flow means 28 is fixed to the supporting frame 18. Said laminar flow means 28 is supplied with energy from the battery 20 in the lifting carriage 16 and produces a laminar flow of cleaned air in the loading area 22, said air flow being schematically shown by arrows 30. The laminar air flow 30 in the loading area 22 is permanently maintained to comply with the cleanliness requirements during operation of the freeze drying plant. If the laminar air flow 30 in the loading area 22 is interrupted, complex evidence must be provided that a product subsequently loaded is not contaminated by contaminants in the loading area 22.

A control cabinet 32 is fixed to the side of the supporting frame 18. On the upper side of the supporting frame 18 a WLAN interface 34 and a laser 36 are arranged. The laser 36 together with mirrors 38 forms part of a laser navigation system for determining the position of the transfer means 10. The positional data can be transmitted via the WLAN interface 34 to an external WLAN interface 40 of a central control computer. The central control computer can determine the required control commands for the drive motor, the steering means and the lifting means of the lifting carriage 16 on the basis of the positional data. These control commands are transmitted to the data transmission interface 34 of the transfer means 10 and sent via the control cubicle 32 to the drive motor, the steering means and/or the lifting means.

In front of the freeze drying station 12 coupling element 40 in the form of truncated raised portions are arranged on the floor. In the lowered state, the coupling elements 40 engage with corresponding coupling means 42 on the lower side of the supporting frame 18. The conical shape of the coupling elements 40 allows for a fine positioning of the supporting frame 18 relative to the freeze drying station 12. Typically, an accuracy of max. ±½ mm is required for ensuring trouble-free loading of the freeze drying station 12 by the transfer means 10. In the coupled state the coupling elements 40 further fix the supporting frame 18 such that shifting relative to the freeze drying station 12 during the loading process is prevented. Further, both the coupling elements 40 and the coupling means 42 comprise electrical contacts which, when an electrical contact is applied, start loading of the freeze drying station 12 or charge the battery 20 of the lifting carriage 16.

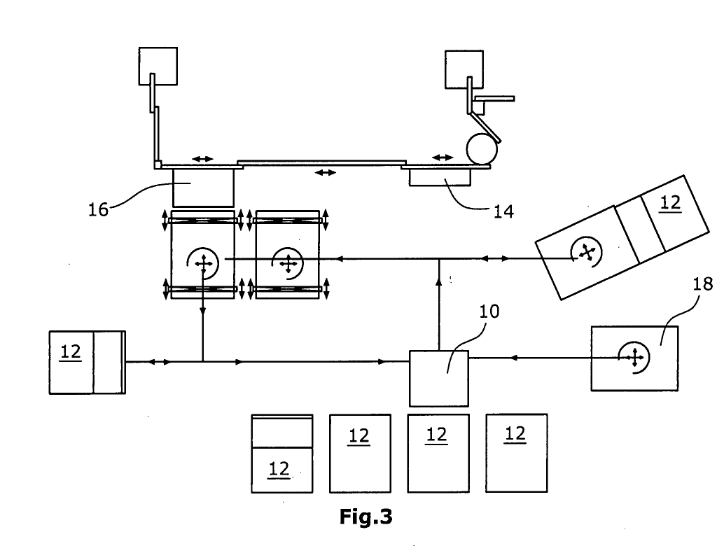

FIG. 3 shows a schematic representation of a top view of a freeze drying plant according to the invention. The freeze drying means comprises a transfer carriage 10, six freeze drying stations 12 and two loading and unloading stations 14,16, wherein the loading station 14 is an unloading station and the loading station 16 is a loading station. Further, the freeze drying plant comprises a service area 18 into where a supporting frame 18 or a lifting carriage 16 can be placed for maintenance, cleaning and/or sterilization purposes. The arrows in FIG. 3 show possible directions of movement and paths of the transfer means 10. In FIG. 3 the transfer means 10 is in a position in front of one of the freeze drying stations 12. For loading the loading area 22 of the transfer means 10 the supporting frame 18 is moved by the lifting carriage 16 to a place in front of the loading station 14. Here, the lifting carriage 16 can put down the supporting frame 18 and, while loading is carried out by the loading station 14, move another supporting frame, e.g. from another freeze drying station 12, to the unloading station 14 or to the service area 18. When the loading area 22 is loaded by the loading station 16 the lifting carriage 16 lifts the loaded supporting frame 18 and moves the supporting frame 18 to the desired freeze drying station 12. Here, too, the lifting carriage 16 can put down the supporting frame 18. While the freeze drying station is loaded with the products in the loading area 22 the lifting carriage 16 can move another supporting frame 18, e.g. from a freeze drying station 12 to the loading station 16 or into the service area 18.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A transfer means (10) for a freeze drying plant comprising at least one freeze drying station (12) and at least one loading station (14,16), wherein said transfer means (10) comprises at least one supporting frame (18) having one loading area (22) and at least one laminar flow means (28) for producing a laminar flow (30) in the loading area (22),
wherein said transfer means (10) comprises a lifting carriage (16) which is adapted to be mechanically connected therewith for lifting and moving said supporting frame (18) and is provided with a drive motor and a steering means.

2. The transfer means (10) according to claim 1, wherein the lifting carriage (16) comprises an energy supply means (20) and is electrically connectable with the supporting frame (18) such that the laminar flow means (28) is connected with the energy supply means (42).

3. The transfer means (10) according to claim 1, wherein said transfer means (10) comprises a coupling means which is configured such that it engages with corresponding coupling elements (40) at the freezing and/or loading station (12,16).

4. The transfer means (10) according to claim 3, wherein the coupling means comprises electrical contacts for contacting electrical contacts of the coupling elements (40) in the coupled state.

5. The transfer means (10) according to claim 1, wherein the lifting carriage (16) has a larger width than the supporting frame (18) and thus is configured to lift a plurality of supporting frames (18).

6. The transfer means (10) according to claim 1, wherein said transfer means (10) comprises a navigation device (36,38) for determining the position of said transfer means (10).

7. The transfer means (10) according to claim 1, wherein said transfer means (10) comprises a data transmission interface (34) for receiving control commands for the drive motor and the steering means.

8. The transfer means (10) according to claim 1, wherein the drive motor and the steering means are configured such that the lifting carriage (16) can be moved forward, backward and sideways and rotated about a vertical axis.

9. A freeze drying plant comprising at least one transfer means (10) according to claim 1, at least one freeze drying station (12) and at least one loading station (16).

10. The freeze drying plant according to claim 9, wherein the freeze drying station (12) and/or the loading station (14) comprise coupling elements (40) for engaging with a corresponding coupling means of the transfer means (10).

11. The freeze drying plant according to claim 10, wherein the coupling elements (40) comprise electrical contacts for contacting electrical contacts of the coupling means in the coupled state.

12. The freeze drying plant according to claim 9, wherein a plurality of supporting frames (18) are assigned to each transfer means (10).

13. The freeze drying plant according to claim 9, wherein the freeze drying plant comprises a separate parking station for maintenance loading and cleaning of the transfer means (10) and/or the lifting carriage (16).

14. The freeze drying plant according to claim 9, wherein the loading station (16) comprises a conveyor means for conveying the product to be freeze-dried, with the conveying means conveying the product directly into the loading area (22) of the transfer means (10).

15. The freeze drying plant according to claim 9, wherein the unloading station (14) comprises a conveying means for conveying the product to be freeze-dried, with the conveying means taking over the product directly from the loading area (22) of the transfer means (10) and separately feeding it to a downstream means.
